(19) United States
(12) Patent Application Publication
(10) Pub. No.: US 2008/0024516 A1
(43) Pub. Date: Jan. 31, 2008

(54) Electronic device and program product

(75) Inventor: Masaki Ebi, Kariya-city (JP)

Correspondence Address: POSZ LAW GROUP, PLC, 12040 SOUTH LAKES DRIVE, SUITE 101, RESTON, VA, 20191, US

(73) Assignee: DENSO CORPORATION, Kariya-city (JP)

(21) Appl. No.: 11/826,554

(22) Filed: Jul. 17, 2007

(30) Foreign Application Priority Data
Jul. 25, 2006 (JP) JP2006-202583

(51) Int. Cl. G09G 5/02

(52) U.S. Cl. 345/594

(57) ABSTRACT

In an electronic device, display colors of an operation key shown on a display is controlled with a simple configuration in both the cases of selecting the operation key with a cursor and selecting the operation key by touch of a user. An electronic control unit displays an operation key with display colors set at a color pallet A when the operation key is selected by a remote control, and displays an operation key with display colors set at a color pallet B when the operation key is selected by touch to a touch display formed on the display.

### CROSS REFERENCE TO RELATED APPLICATION

This application is based on and incorporates herein by reference Japanese Patent Application No. 2006-202583 filed on Jul. 25, 2006.

### FIELD OF THE INVENTION

The present invention relates to an electronic device and a program product which allow a display color control of an operation key selected by a touch panel and, further, a display color control of an operation key selected via a cursor operated by a remote control or the like.

### BACKGROUND OF THE INVENTION

A known device shows an operation screen differently according to whether a display has a touch panel or not. For example, a device shown in Patent Document 1 judges if a display connected to the device has a touch panel by reading a predetermined type-identifying signal set beforehand or by trying to send and receive a control signal for a touch panel. When the device judges that the display has a touch panel, a first operation screen, which facilitates the operations of the device with the touch panel, is displayed on the display. When the device judges that the display does not have a touch panel, a second operation screen, which facilitates the operations of the device with a remote control, is displayed on the display.

Patent Document 1: JP-2005-267450 A

Meanwhile, a display color control in an operation key selected by a touch panel is different from that selected by a remote control via a cursor. Thus, conventionally, software programs for the two display color controls are individually made. This is not preferable from the viewpoints of designs and costs.

### SUMMARY OF THE INVENTION

The present invention has been established in view of the above problems and an object of the present invention is to provide an electronic device and a program product which allow display colors of an operation key to be controlled with a simple configuration in both the cases of selecting the operation key with a cursor and selecting the operation key by touch of a user.

To achieve the above object, according to an aspect of the present invention, an electronic device is provided as follows. A display unit is included for displaying an operation key. At least one of a first selection unit and a second selection unit is included. The first selection unit is for selecting the operation key with a cursor shown on the display unit, while the second selection unit is for selecting the operation key by detecting touch to the operation key on the display unit. A display control unit is included for controlling the operation key and the cursor shown on the display unit. A control unit is included for performing an operation corresponding to the operation key selected by the first or second selection unit. Here, the display control unit allows the operation key to be displayed on the display unit (i) with display colors of a first display color group when the first selection unit performs a selection operation for selecting the operation key and (ii) with display colors of a second display color group when the second selection unit performs a selection operation for selecting the operation key.

According to another aspect of the present invention, a computer program product in a computer-readable medium is provided in use of controlling on a display means a display color for an operation key selectable by at least one of two selection means. The two selection means include a first selection means for selecting the operation key with a cursor shown on the display means and a second selection means for selecting the operation key by detecting touch to the operation key on the display means. The program product comprises instructions of: determining whether a selection operation for selecting the operation key on the display means is performed by the first selection means or the second selection means; displaying the operation key on the display means with display colors of a first display color group when a selection operation is determined to be performed by the first selection means; and displaying the operation key on the display means with display colors of a second display color group when a selection operation is determined to be performed by the second selection means.

### BRIEF DESCRIPTION OF THE DRAWINGS

The above and other objects, features, and advantages of the present invention will become more apparent from the following detailed description made with reference to the accompanying drawings. In the drawings:

FIG. 1 is a block diagram showing a general configuration of an electronic device according to a first embodiment of the present invention;

FIG. 2 shows a display example of an operation screen when a switch command is output from a remote control and thereby the display screen of a touch display is switched to the operation screen in an electronic device according to the first embodiment;

FIG. 3 shows a display example of an operation screen when the operation screen shown in FIG. 2 is displayed on the touch display and a transfer command (to the right) is output from the remote control in an electronic device according to the first embodiment;

FIG. 4 shows a display example of an operation screen when the switch indication key of a touch display is touched and thereby the display screen of the touch display is switched to the operation screen in an electronic device according to the first embodiment;

FIG. 5 is a block diagram showing a general configuration of an electronic device according to a second embodiment of the present invention; and

FIG. 6 is a block diagram showing a general configuration of an electronic device according to a third embodiment of the present invention.

### DETAILED DESCRIPTION OF THE PREFERRED EMBODIMENTS

### First Embodiment

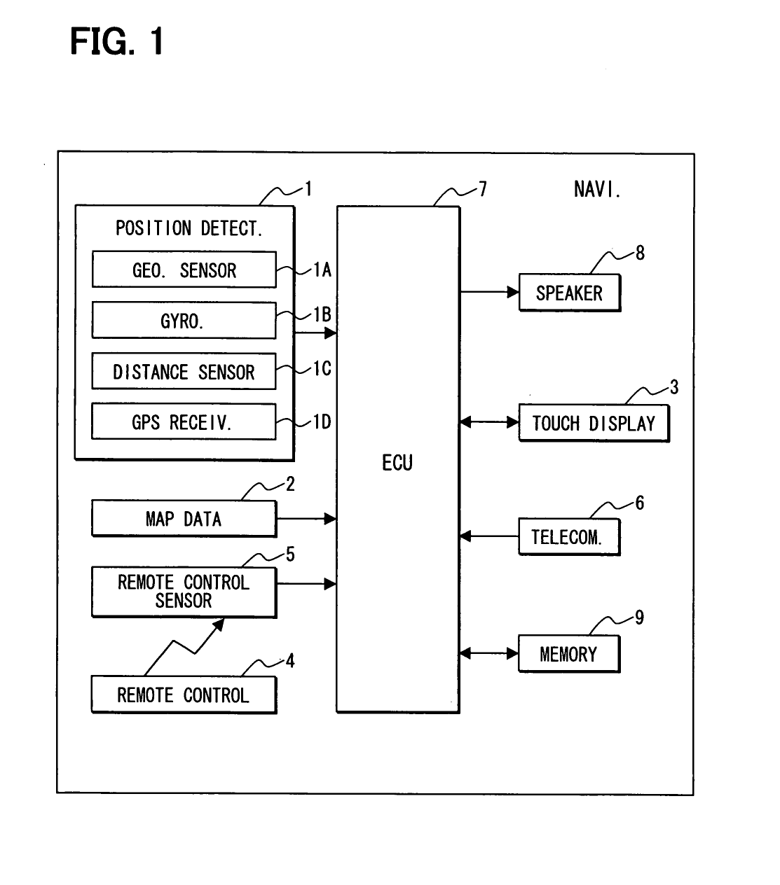

FIG. 1 is a block diagram showing the general configuration of an electronic device according to a first embodiment of the present invention. The electronic device is operated in the state of being incorporated into a navigator for a vehicle.

In FIG. 1, a position detector 1 comprises a geomagnetic sensor 1A, a gyroscope 1B, a distance sensor 1C, and a GPS receiver 1D and detects the present position and the traveling direction of a vehicle.

The geomagnetic sensor 1A has a configuration wherein a circular ferromagnetic material such as permalloy or the like is wrapped with an excitation winding to excite the material and two detection windings orthogonal to each other to detect directions. The geomagnetic sensor 1A measures the voltage generated in the two detection windings by applying an AC voltage to the excitation winding and detects the traveling direction of a vehicle as the absolute direction on the basis of the measured voltage.

The gyroscope 1B is equipped with a crystal oscillator for example and detects a yaw angular velocity (a yaw rate) of a vehicle from the oscillation based on Coriolis force generated when the oscillator is oscillated.

The distance sensor 1C detects a travel distance of a vehicle, for example, on the bases of the rotation signals of the wheels and axles, which are not shown in the figure, mounted on the vehicle.

The GPS receiver 1D receives GPS signals for position measurement sent from a GPS satellite which is an artificial satellite and is not shown in the figure and detects the latitude, the longitude and the height of the position where a vehicle currently travels.

The position detector 1 detects the present position and the traveling direction of a vehicle with a high degree of accuracy by mutually complementing the results detected with the four devices mentioned above. It goes without saying that it is not necessary to have all of the aforementioned four devices in some degrees of required detection accuracy. Here, the present position and the traveling direction of a vehicle may be detected on the basis of the detected results obtained by detecting the accelerations of the vehicle in the transverse and vertical directions with a three-dimensional gyroscope for example. Otherwise, they may be detected on the basis of the detected signals from another sensor such as a steering sensor or the like.

A map data memory 2 has a hard disk for example as a storage medium and stores: map data including road information, traffic regulation information, building information, the address information and postal code information of each region, and others; and map image data to display map images. The map data and the map image data can be renewed. The map data and the map image data may be stored in a CD-ROM, a DVD-ROM, or the like.

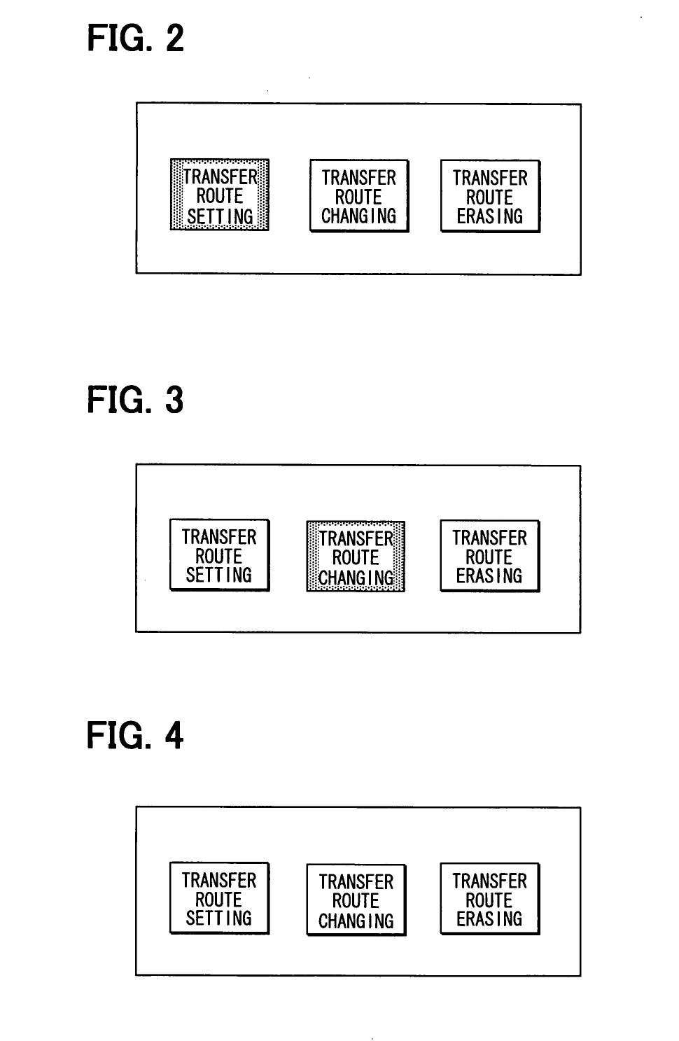

A touch display 3 is a display, which functions as a display means or unit. Further, the touch display 3 has in the front a touch panel for detecting which position on a display screen a user has touched and outputting a signal showing the touched position on the display screen. The touch display 3 displays: a navigation screen including map image display; and an operation screen to display operation keys to indicate various navigation operations (refer to FIG. 2). Each of the operation keys comprises: a shape image to show the shape of the operation key; and a character image to show the navigation operation corresponding to the operation key. Further, the touch display 3 always displays a switch indication key to direct the navigation screen and the operation screen to be alternately displayed. The touch display 3 functions as a second selection means or unit.

A remote control 4 has a cursor key, a decision key, and a switch indication key, those being not shown in the figure, and indicates the start and the end of various navigation operations through a remote control sensor 5. More specifically, when the switch indication key is pushed, the remote control 4 outputs a switch command to direct the navigation screen and the operation screen displayed on the touch display 3 to be switched to each other. Further, when the cursor key is pushed, the remote control 4 outputs a transfer command to direct a cursor displayed on the operation screen of the touch display 3 to move in the direction where the cursor key is pushed. When the decision key is pushed, the remote control 4 outputs an execution command to direct the navigation operation corresponding to the operation key selected by the cursor on the operation screen of the touch display 3 to be executed. The remote control 4 functions as a first selection means or unit.

A telecommunication device 6 is a small telecommunication device for a vehicle and receives traffic congestion information and traffic regulation information transmitted from a VICS (Vehicle Information and Communication System) information center not shown in the figure. The traffic congestion information and the traffic regulation information may be received through FM broadcasting or the like.

An ECU (Electronic Control Unit) 7 comprises a known computer and carries out various navigation operations including map image display. More specifically, the ECU 7 reads the map image data in the vicinity of the present position of a vehicle from the map data memory 2 on the basis of the present position and the traveling direction of the vehicle detected by the position detector 1, and obtains the traffic congestion information and the traffic regulation information via the telecommunication device 6. Then the ECU 7 displays the map image formed by superimposing a mark showing the present position of the vehicle, the traffic congestion information, and the traffic regulation information on the touch display 3 as a navigation screen, and offers various voice guides through a speaker 8.

In addition, when it is judged from the signal output from the touch display 3 that the switch indication key is touched or when a switch command is output from the remote control 4, the ECU 7 switches the navigation screen and the operation screen displayed on the touch display 3 to each other. When a transfer command is output from the remote control 4, the ECU 7 moves the cursor displayed on the operation screen of the touch display 3 in the direction shown by the transfer command. When an execution command is output from the remote control 4, the ECU 7 carries out the navigation operation corresponding to the operation key selected by the cursor on the operation screen of the touch display 3. When a user touches the operation key displayed on the operation screen of the touch display 3 too, the same is true.

Next, an operation as a feature of the present embodiment will be explained. In the operation, the ECU 7 controls the display colors of an operation key displayed on the operation screen of the touch display 3 in accordance with a display control program.

Firstly, the following explains a color pallet A (a first display color group) and a color pallet B (a second display color group) which the ECU 7 has.

The color pallet A comprises four pallets of a pallet A1 to a pallet A4 and the display colors of an operation key are set when the operation key displayed on the operation screen of the touch display 3 is selected by using the remote control 4. More specifically, the display color of the shape image and the display color of the character image of an operation key are set at the pallet A1 and the pallet A2 (display colors at non-selection) when the operation key is not selected by the cursor, and the display color of the shape image and the display color of the character image of an operation key are set at the pallet A3 and the pallet A4 (display colors at selection) when the operation key is selected via the cursor by the remote control 4.

The color pallet B comprises four pallets of a pallet B1 to a pallet B4 and the display colors of an operation key are set by user's touch to the touch display 3 when the operation key displayed on the operation screen of the touch display 3 is selected. More specifically, the display color of the shape image and the display color of the character image of the operation key are set at the pallet B1 and the pallet B2 (display colors at non-selection) when the operation key is not touched (not selected), and the display color of the shape image and the display color of the character image of an operation key are set at the pallet B3 and the pallet B4 (display colors at selection) when the operation key is touched (selected).

Secondly, the following explains controlling by the ECU 7 of the display colors of an operation key displayed on the operation screen of the touch display 3 in accordance with a display control program by using the aforementioned color pallet A and color pallet B.

A switch command is output from the remote control 4 and thereby the display screen of the touch display 3 is switched to the operation screen. This can be called a selection operation (i.e., a selection trigger operation) for selecting an operation key by the first selection means (i.e., remote control 4). Further, this may function as a determining means or unit for determining that a selection trigger operation for selecting an operation key is performed by the first selection means. Thus, the ECU 7 recognizes that the remote control 4 is installed in the device, and displays the shape images and the character images of the operation keys displayed on the operation screen with the display colors set at the pallet A1 and the pallet A2 of the color pallet A. Thereafter, the ECU 7 displays a cursor on one of the operation keys displayed on the operation screen.

The cursor is displayed by displaying (changing) the display colors of the shape image and the character image of one of the operation keys displayed on the operation screen with the display colors set at the pallet A3 and the pallet A4 of the color pallet A. That is, the cursor is not displayed independently from the operation key but displayed by differentiating the display colors of the shape image and the character image of the selected operation key from the display colors of the shape image and the character image of each of the other operation keys (refer to FIG. 2).

Then, when a transfer command is output from the remote control 4, the ECU 7 moves the cursor by one step in the direction shown by the transfer command. That is, the ECU 7 displays (changes) the display colors of the shape image and the character image of the operation key currently selected from among the operation keys displayed on the operation screen by the cursor with the display colors set at the pallet A1 and the pallet A2 of the color pallet A, and displays (changes) the display colors of the operation key adjacent to the selected operation key in the direction shown by the transfer command output from the remote control 4 with the display colors set at the pallet A3 and the pallet A4 of the color pallet A (refer to FIG. 3). When an execution command is output from the remote control 4, the ECU 7 carries out the navigation operation corresponding to the operation key selected by the cursor.

Meanwhile, a switch indication key in the touch display 3 is touched and thereby the display screen of the touch display 3 is switched to the operation screen. This can be called a selection operation (i.e., a selection trigger operation) for selecting an operation key by the second selection means (i.e., touch display 3). Further, this may function as a determining means or unit for determining that a selection trigger operation for selecting an operation key is performed by the second selection means. Thus, the ECU 7 recognizes that the touch display 3 is installed in the device and displays the shape images and the character images of the operation keys displayed on the operation screen with the display colors set at the pallet B1 and the pallet B2 of the color pallet B (refer to FIG. 4). When a user touches an operation key displayed on the operation screen, the ECU 7 displays (changes) the shape image and the character image of the touched operation key with the display colors set at the pallet B3 and the pallet B4 of the color pallet B, and carries out the navigation operations corresponding to the touched operation key.

Here, even when a switch command is output from the remote control 4 and thereby the display screen of the touch display 3 is switched to the operation screen, an operation key thereafter displayed on the operation screen may be touched by a user in some cases. In such a case, touching of the operation key functions as another selection operation for selecting an operation key by the second selection means (i.e., touch display 3). Thus, the ECU 7 carries out the same operations as the operations carried out when the display screen of the touch display 3 is switched to the operation screen after touching of the switch indication key.

Further, even when the switch indication key in the touch display 3 is touched and thereby the display screen of the touch display 3 is switched to the operation screen, thereafter a transfer command may be output from the remote control 4 in some cases. In such a case, outputting of the transfer command functions as another selection operation for selecting an operation key by the first selection means (i.e., remote control 4). Thus, the ECU 7 carries out the same operations as the operations carried out when the display screen of the touch display 3 is switched to the operation screen after outputting the switch command from the remote control 4.

The purpose is to display an operation key with the display color set at the corresponding color pallet even when a user uses either the touch display 3 or the remote control 4.

In addition, the display position on the operation screen and the display criterion (such as dimension or scale) of an operation key displayed on the operation screen when the operation screen is switched by one of the above two methods are the same as those when the operation screen is switched by the other of the above two methods. The purpose is to share the image data of the shape image and the character image displaying the operation key.

Here, the ECU 7 functions as a display control means or unit.

A memory 9 is used as a storage region when the ECU 7 carries out various operations. As the memory 9, a memory card or the like is used for example.

Next, a specific example will be explained. Here, the ECU 7 controls the display colors of an operation key displayed on the operation screen of the touch display 3 in accordance with a display control program. Here, in the example below, the white color and the black color are set at the pallet A1 and the pallet A2 of the color pallet A. The black color produced by reversing the display color (white) of the pallet A1 is set at the pallet A3 and the white color produced by reversing the display color (black) of the pallet A2 is set at the pallet A4. Further, the white color is set at the pallet B1 and the pallet B3 of the color pallet B and the black color is set at the pallet B2 and the pallet B4.

FIG. 2 represents an example of display on an operation screen when a switch command is output from the remote control 4 and thereby the display screen of the touch display 3 is switched to the operation screen. In FIG. 2, as the operation keys displayed on the operation screen, there are three keys of “transfer route setting,” “transfer route changing,” and “transfer route erasing.” It is understood that, among the three operation keys, with regard to the “transfer route setting” operation key selected by the cursor, the shape image and the character image thereof are displayed with the display colors (black and white) set at the pallet A3 and the pallet A4 of the color pallet A. Further, with regard to the other “transfer route changing” and “transfer route erasing” operation keys, the shape images and the character images thereof are displayed with the display colors (white and black) set at the pallet A1 and the pallet A2 of the color pallet A. Thus, the display colors set at the pallet A3 and the pallet A4 in the color pallet A are produced by revering the display colors set at the pallet A1 and the pallet A2. It is therefore possible for a user to identify the operation key selected by the remote control 4 at a glance.

FIG. 3 represents an example of display on an operation screen when the operation screen shown in FIG. 2 is displayed on the touch display 3 and a transfer command (to the right) is output from the remote control 4. It is understood that, in FIG. 3, the cursor that has selected the “transfer route setting” operation key in FIG. 2 moves to the “transfer route changing” operation key adjacent on the right to the operation key, and the shape image and the character image of the “transfer route changing” operation key are displayed with the display colors (black and white) set at the pallet A3 and the pallet A4 of the color pallet A. Further, with regard to the other “transfer route setting” and “transfer route erasing” operation keys, the shape images and the character images thereof are displayed with the display colors (white and black) set at the pallet A1 and the pallet A2 of the color pallet A.

FIG. 4 represents an example of display on an operation screen when the switch indication key in the touch display 3 is touched and thereby the display screen of the touch display 3 is switched to the operation screen.

In FIG. 4, the shape images and the character images of the three “transfer route setting,” “transfer route changing,” and “transfer route erasing” operation keys displayed on the operation screen are displayed with the display colors (white and black) set at the pallet B1 and the pallet B2 of the color pallet B. When a user touches one of the three operation keys, the ECU 7 displays the display colors of the shape image and the character image of the operation key with the display colors (white and black) set at the pallet B3 and the pallet B4 of the color pallet B. Note that, in the example of display on the operation screen shown here, the same white display color is set at the pallet B1 and the pallet B3 of the color pallet B and the same black display color is set at the pallet B2 and the pallet B4, and therefore the colors are the same as the colors shown in FIG. 4. The reason why a same display color is applied to the pallet B1 and the pallet B3 of the color pallet B and the pallet B2 and the pallet B4 of the color pallet B, respectively, is that, with regard to the operation key selected by user's touch to the touch display 3, it is estimated that the user well recognizes that the operation key is selected and thus the operation key is displayed without giving discomfort to the user.

Here, when the operation screen shown in FIG. 2 is displayed on the touch display 3 and a user touches one of the operation keys displayed on the operation screen, the operation screen shown in FIG. 4 is displayed instantaneously on the touch display 3. Further, when the operation screen shown in FIG. 4 is displayed on the touch display 3 and a transfer command is output from the remote control 4, the operation screen shown in FIG. 2 is displayed instantaneously on the touch display 3.

As it can be understood from the examples shown in FIGS. 2 to 4, with regard to an operation key selected by the cursor or user's touch, the display colors of the shape image and the character image of the operation key are displayed with the display colors set at the pallet A3 and the pallet A4 of the color pallet A and the pallet B3 and the pallet B4 of the color pallet B. As a result, a user can recognize also the operation corresponding to the selected operation key without fail.

As stated above, in an electronic device of the present embodiment, the ECU 7 displays an operation key with the display colors set at the color pallet A when the operation key is selected with the remote control 4, and displays an operation key with the display colors set at the color pallet B when the operation key is selected by touch to the touch display 3. The control method on the display colors of an operation key has heretofore been different between when a remote control is provided and when a touch display is provided and hence a display control program itself has been made separately. By the display control means of the present device however, the operation keys of the same appearance except the display colors are displayed in both the cases where a remote control is provided and where a touch display is provided, and hence a display control program can be commonly used in both the cases. Therefore, it is possible to control the display colors of an operation key with a simple configuration when the operation key is selected with a remote control and when the operation key is selected by touch of a user, and that is preferable from the viewpoints of design and cost.

### Second Embodiment

Next, a second embodiment of the present invention is explained. An electronic device according to the present embodiment is characterized in that: the electronic device is operated in the state of being incorporated into a navigator for a vehicle in the same way as the aforementioned first embodiment; but a touch display is not provided; and the device used for the selection of an operation key displayed on the operation screen is only a remote control.

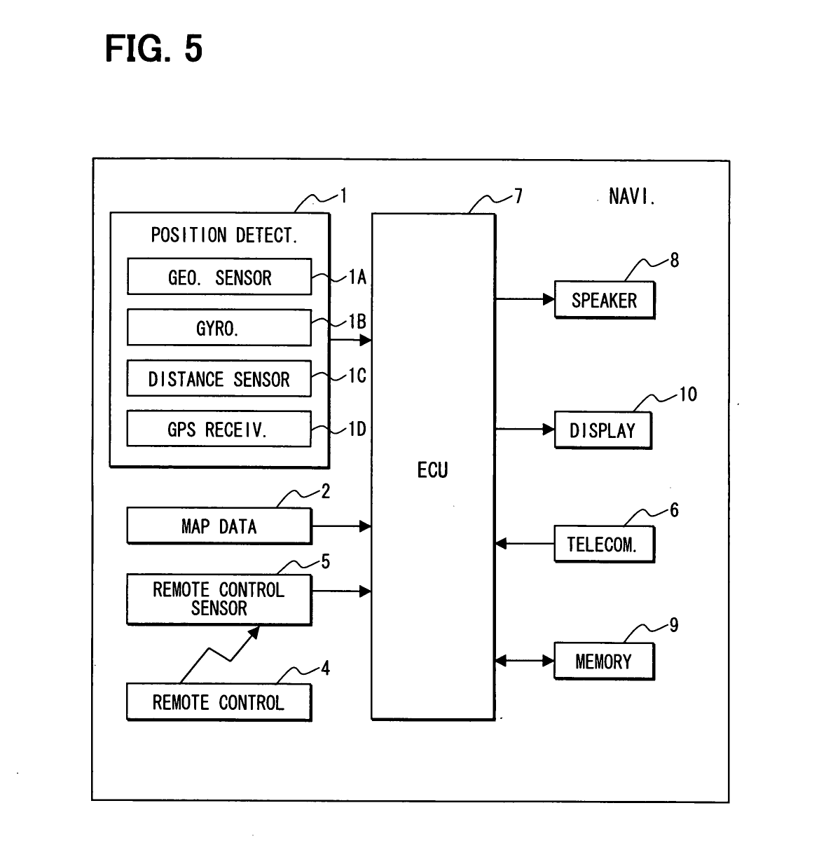

FIG. 5 is a block diagram showing the general configuration of an electronic device according to the second embodiment of the present invention.

A display 10 is provided in place of the touch display 3 used in the aforementioned first embodiment, and displays a navigation screen and an operation screen.

An ECU 7 in the present embodiment has a color pallet A and a color pallet B in the same way as the aforementioned embodiment, but the operation key displayed on the operation screen of the display 10 is selected only with the remote control 4, and hence the display color control of an operation key with the color pallet B is not carried out. That is, the ECU 7 carries out the display color control of an operation key when the operation key is selected with the remote control 4 and the same display control program as used in the aforementioned first embodiment is used.

Other mechanical configurations and operations are identical to those in the aforementioned first embodiment and thus the explanations are omitted.

As stated above, in an electronic device of the present embodiment, when an operation key is selected with the remote control 4, the operation key is displayed with the display colors set at the color pallet A. A display color control program used on that occasion is the same as that incorporated into a device having both a remote control and a touch display, and hence that is preferable from the viewpoints of design and cost.

### Third Embodiment

Next, a third embodiment of the present invention is explained. An electronic device according to the present embodiment is characterized in that: the electronic device operates in the state of being incorporated into a navigator for a vehicle in the same way as the aforementioned first embodiment; but a remote control is not provided; and the device used for the selection of an operation key displayed on the operation screen is only a touch display.

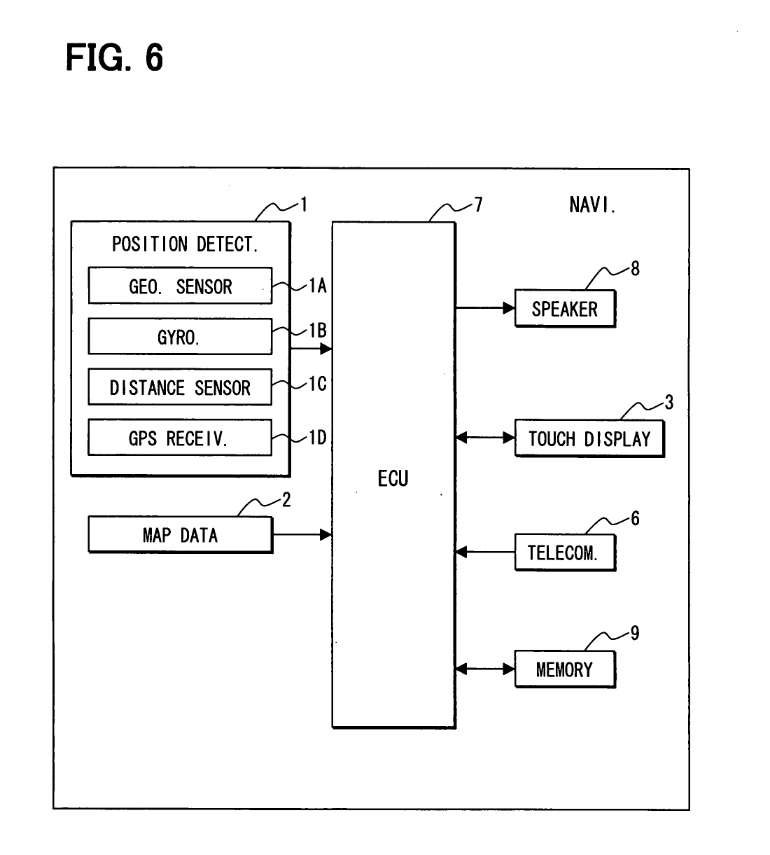

FIG. 6 is a block diagram showing the general configuration of an electronic device according to the third embodiment of the present invention.

An ECU 7 in the present embodiment has a color pallet A and a color pallet B in the same way as the aforementioned embodiments, but the operation key displayed on the operation screen of the touch display 3 is selected only by touch to the touch display 3, and hence the display color control of an operation key with the color pallet A is not carried out. That is, the ECU 7 carries out the display color control of an operation key when the operation key is selected with the touch display 3, and the same display color control program as used in the aforementioned first embodiment is used.

Other mechanical configurations and operations are identical to those in the aforementioned first embodiment and thus the explanations are omitted.

As stated above, in an electronic device of the present embodiment, when an operation key is selected by touch to the touch display 3, the operation key is displayed with the display colors set at the color pallet B. A display color control program used on that occasion is the same as that incorporated into a device having both a remote control and a touch display, and hence that is preferable from the viewpoints of design and cost.

In the aforementioned embodiments, the present electronic device is operated in the state of being incorporated into a navigator for a vehicle. However, the present electronic device is not limited to the embodiments and can be suitably used as long as the electronic device has either one or both of a remote control and a touch display.

Each or any combination of processes, steps, or means explained in the above can be achieved as a software unit (e.g., subroutine) and/or a hardware unit (e.g., circuit or integrated circuit), including or not including a function of a related device; furthermore, the hardware unit can be constructed inside of a microcomputer.

Furthermore, the software unit or any combinations of multiple software units can be included in a software program, which can be contained in a computer-readable storage media or can be downloaded and installed in a computer via a communications network.

(Features)

Features of the subject matter described herein are set out in the following clauses.

As a first feature, an electronic device is provided as follows. A display unit is included for displaying an operation key. At least one of a first selection unit and a second selection unit is included. The first selection unit is for selecting the operation key with a cursor shown on the display unit, while the second selection unit is for selecting the operation key by detecting touch to the operation key on the display unit. A display control unit is included for controlling the operation key and the cursor shown on the display unit. A control unit is included for performing an operation corresponding to the operation key selected by the first or second selection unit. Here, the display control unit allows the operation key to be displayed on the display unit (i) with display colors of a first display color group when the first selection unit performs a selection operation for selecting the operation key and (ii) with display colors of a second display color group when the second selection unit performs a selection operation for selecting the operation key.

As stated above, in the above electronic device as the first feature, the display control unit allows an operation key to be displayed on the display unit by using one of the two display color groups depending on whether the selection operation is performed by the first or second selection unit. In contrast, conventionally, the display control programs have been individually made for two selection units since the display colors of operation keys are controlled differently between when the first selection unit is provided and when the second selection unit is provided. However, in the display control unit of the present device, since the operation keys of the same appearance except the display colors are displayed, both when the first selection unit is provided and when the second selection unit is provided, a single display control program can be commonly used in both the cases. Consequently, it is possible to control the display colors of an operation key with a simple configuration when the operation key is selected with a cursor and when the operation key is selected by touch of a user. That is preferable from the viewpoints of design and cost.

As an optional characteristic of the above first feature, the first and second display color groups may have display colors at selection as display colors to display an operation key selected by the first or second selection unit and display colors at non-selection as display colors to display operation keys not selected by the first or second selection unit. The display control unit may display the operation key selected by the first or second selection unit with the display colors at selection and the operation keys not selected by the first or second selection unit with the display colors at non-selection.

Further, the display colors at selection in the first display color group may be the display colors produced by reversing the display colors at non-selection in the first display color group. A user can thereby recognize the operation key selected by the first selection unit at a glance at the display unit.

Further, the display colors at selection in the second display color group may be the same display colors as the display colors at non-selection in the second display color group. The operation key selected by the second selection unit is the operation key selected by user's touch to the display unit, and thus it is estimated that the user well recognizes that the operation key is selected. Therefore, an operation key can be displayed without giving discomfort to a user by applying the same display colors to the display colors at selection and the display colors at non-selection in the second display color group.

Further, the operation key may comprise a shape image showing the shape of the operation key and a character image showing the operation corresponding to the operation key; and the first and second display color groups have the display colors at selection and the display colors at non-selection for displaying each of the shape image and the character image. A user can thereby well recognize not only the operation key selected by the user but also the operation corresponding to the selected operation key.

Further, the cursor may be indicated by displaying the operation key using display colors at selection in the first display color group.

As another optional characteristic of the above first feature, the present electronic device may be operated in the state of being incorporated into a navigator (i.e., navigation apparatus) for a vehicle.

As a second feature, a computer program product in a computer-readable medium is provided in use of controlling on a display means a display color for an operation key selectable by at least one of two selection means including a first selection means for selecting the operation key with a cursor shown on the display means and a second selection means for selecting the operation key by detecting touch to the operation key on the display means. The program product comprises instructions of: determining whether a selection operation for selecting the operation key on the display means is performed by the first selection means or the second selection means; displaying the operation key on the display means with display colors of a first display color group when a selection operation is determined to be performed by the first selection means; and displaying the operation key on the display means with display colors of a second display color group when a selection operation is determined to be performed by the second selection means.

The functions and effects of the program product as the second feature are the same as the functions and effects of the electronic device as the first feature.

It will be obvious to those skilled in the art that various changes may be made in the above-described embodiments of the present invention. However, the scope of the present invention should be determined by the following claims.

What is claimed is:

1. An electronic device comprising:
a display unit for displaying an operation key;
at least one of a first selection unit and a second selection unit, the first selection unit for selecting the operation key with a cursor shown on the display unit, the second selection unit for selecting the operation key by detecting touch to the operation key on the display unit;
a display control unit for controlling the operation key and the cursor shown on the display unit; and
a control unit for performing an operation corresponding to the operation key selected by the first or second selection unit, wherein
the display control unit allows the operation key to be displayed on the display unit (i) with display colors of a first display color group when the first selection unit performs a selection operation for selecting the operation key and (ii) with display colors of a second display color group when the second selection unit performs a selection operation for selecting the operation key.

2. The electronic device of claim 1, wherein:
the first display color groups have display colors at selection and display colors at non-selection, the display colors at selection in the first display color group being used for the display control unit to display an operation key selected by the first selection unit, the display colors at non-selection in the first display color group being used for the display control unit to display an operation key not selected by the first selection unit; and
the second display color groups have display colors at selection and display colors at non-selection, the display colors at selection in the second display color group being used for the display control unit to display an operation key selected by the second selection unit, the display colors at non-selection in the second display color group being used for the display control unit to display an operation key not selected by the second selection unit.

3. The electronic device of claim 2, wherein
the display colors at selection in the first display color group are the display colors produced by reversing the display colors at non-selection in the first display color group.

4. The electronic device of claim 2, wherein
the display colors at selection in the second display color group are same display colors as the display colors at non-selection in the second display color group.

5. The electronic device of claim 2, wherein:
the operation key comprises a shape image showing a shape of the operation key and a character image showing an operation corresponding to the operation key; and
the first and second display color groups have the display colors at selection and the display colors at non-selection for displaying each of the shape image and the character image.

6. The electronic device of claim 2, wherein
the cursor is indicated by displaying the operation key using display colors at selection in the first display color group.

7. The electronic device of claim 1, wherein
the electronic device is operated in a state of being incorporated into a navigator for a vehicle.

8. A computer program product in a computer-readable medium in use of controlling on a display means a display color for an operation key selectable by at least one of two selection means including a first selection means for selecting the operation key with a cursor shown on the display means and a second selection means for selecting the operation key by detecting touch to the operation key on the display means; the program product comprising instructions of:
determining whether a selection operation for selecting the operation key on the display means is performed by the first selection means or the second selection means;
displaying the operation key on the display means with display colors of a first display color group when a selection operation is determined to be performed by the first selection means; and
displaying the operation key on the display means with display colors of a second display color group when a selection operation is determined to be performed by the second selection means.
